(19) United States
(12) Patent Application Publication
(10) Pub. No.: US 2021/0146682 A1
(43) Pub. Date: May 20, 2021

(54) PRINT FLUID EJECTION NOZZLE HEALTH MEASUREMENT SYSTEM

(71) Applicant: HEWLETT-PACKARD DEVELOPMENT COMPANY, L.P., Spring, TX (US)

(72) Inventors: Sara MOLINS CABANI, Sant Cugat del Valles (ES); Jordi HERNANDEZ CREUS, Sant Cugat del Valles (ES); Diana CANTO ESTANY, Sant Cugat del Valles (ES)

(21) Appl. No.: 16/616,919

(22) PCT Filed: Jul. 17, 2017
(86) PCT No.: PCT/US17/42305

§ 371 Date: Nov. 25, 2019

(51) Int. Cl. B41J 2/045; B41J 2/165

(52) U.S. Cl. CPC B41J 2/0451; B41J 2/04586; B41J 2/16579

(57) ABSTRACT

Example systems to determine print fluid ejection nozzle health for a printer device are disclosed along with corresponding methods. In an example, the system includes an image recording device to record an image of print fluid ejected from a print fluid ejection nozzle and disposed on a printable surface. In addition, the system includes an image processor to analyse the image to provide a result based on a characteristic of the image that are representative of the print fluid disposed on the printable surface. Further, the system includes a controller to receive the result and assign a nozzle health category to the print fluid ejection nozzle in dependence on the result.

### BACKGROUND

In commercially available printers, print fluid ejection nozzles may be of the order of a few hundred microns (approximately one third the width of a human hair). Therefore, nozzles may be partially occluded or even blocked entirely by even relatively small debris, contaminants, or dry print fluid. Such partial occlusion or blocking may reduce the so-called nozzle health of an affected nozzle and possibly detrimentally affect print fluid ejection from the affected nozzle and consequently print image quality. Commercially available printers may use error hiding procedures to compensate for reduced or poor nozzle health.

Drop detection is a method of determining nozzle health. In an example of a commercially available method, a light source illuminates a light sensor in a closed loop circuit. The sensor senses light and changes in the amount of light incident on it. When a nozzle is fired the stream of drops block part of the light, which produces a change in the amount of light the sensor receives. The light source is controlled to output more light in response to the reduction in the amount of light incident on the sensor. When a drop finishes crossing the light beam the sensor sees more light (due to the previous increase) and the light source is controlled to operate at the lower level. This control signal perturbation giving more and less light is indicative of a nozzle being fired and may be utilised by a processor to determine if print fluid is ejected when a nozzle is fired.

### BRIEF DESCRIPTION OF THE DRAWINGS

The present disclosure will now be described, by way of example, and with reference to the accompanying drawings in which:

FIG. 1A is an illustrative schematic diagram of a system to determine print fluid ejection nozzle health in accordance with a first example of the present disclosure;

FIG. 1B is an illustrative schematic diagram of a system to determine print fluid ejection nozzle health in accordance with a second example of the present disclosure;

FIG. 2 is an illustrative schematic diagram of a system to determine print fluid ejection nozzle health in accordance with a third example of the present disclosure;

FIG. 3A is an illustrative schematic diagram of a system to determine print fluid ejection nozzle health in accordance with a fourth example of the present disclosure;

FIG. 3B is an illustrative schematic diagram of a system to determine print fluid ejection nozzle health in accordance with a fifth example of the present disclosure;

FIG. 4A is an illustrative schematic diagram of a print fluid drop pattern in accordance with an example of the present disclosure;

FIG. 4B is an illustrative schematic diagram of a partially analysed/processed print fluid drop pattern in accordance with an example of the present disclosure;

FIG. 4C is an illustrative schematic diagram of a graph indicative of print head nozzle health in accordance with an example the present disclosure;

FIG. 5A is an illustrative schematic diagram of a print fluid drop pattern in accordance with an example of the present disclosure;

FIG. 5B is an illustrative schematic diagram of a partially analysed/processed print fluid drop pattern in accordance with an example of the present disclosure;

FIG. 5C is an illustrative schematic diagram of a graph indicative of print head nozzle health in accordance with an example of the present disclosure;

FIG. 6A is an illustrative schematic flow chart of the printing drop detection and nozzle health system in accordance with an example of the present disclosure; and

FIG. 6B is an illustrative schematic flow chart of the process which analyses a print fluid pattern and assigns the nozzle health in accordance with an example of the present disclosure.

### DESCRIPTION

A description of examples in accordance with the disclosure will now be provided with reference to the drawings and in which like reference numerals refer to like parts.

In general outline, the disclosure relates to a system 9 to determine print fluid ejection nozzle health for a printer device 11. The system 9 comprises an image recording device 5 to record an image 37 of print fluid pattern 35 ejected from a print fluid ejection nozzle 6′, 8′, 10′, 12′, 30′, 32′, 34′, 36′ and disposed on a printable work surface 2, 4, 16, 18. An image processor 7 may analyse the image 37 to provide a value based on a characteristic of the image 37 representative of the print fluid 35 disposed on the printable surface 2, 4, 16, 18. A controller 13 may receive the value and assign a nozzle health category to the print fluid ejection nozzle 6′, 8′, 10′, 12′, 30′, 32′, 34′, 36′ in dependence on the value.

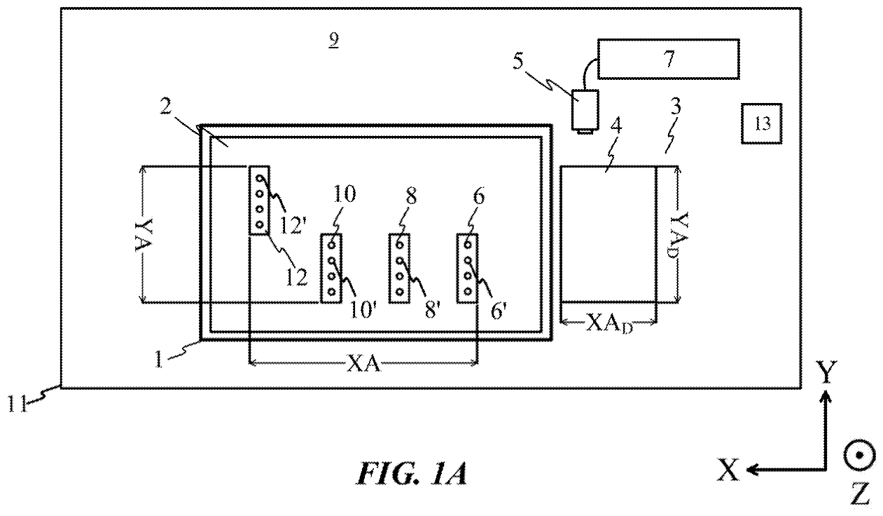

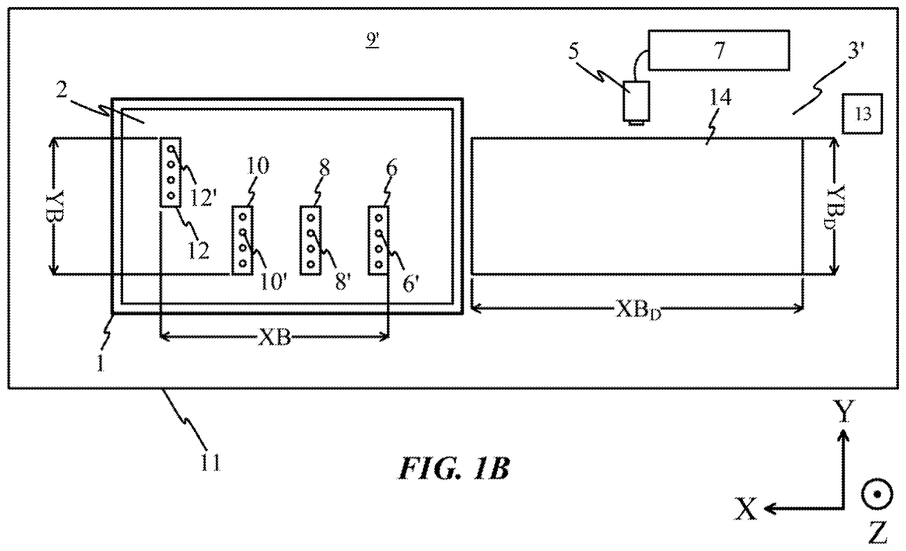

In the first example of the disclosure illustrated in FIG. 1A, a nozzle health determination system 11 comprises a printable work surface 2, digital camera 5, image processor 7 and controller 13. A carriage 1 supports print heads 6, 8, 10, and 12, with respective nozzles 6′, 8′, 10′, 12′, and a swath of size YA by XA. The print heads 6, 8, 10 and 12 eject print fluid through their nozzles 6′, 8′, 10′, 12′, onto a printable work surface 2, such as a sheet of paper, during or as part of a print pass of carriage 1 in the print scan axis (X-axis). In the described disclosure, a nozzle health measurement zone 3 is disposed to a side of the printable work surface 2 so that at every pass when the carriage starts to reduce its speed to change direction a nozzle health measurement may be launched.

The nozzle health measurement zone 3 comprises a printable surface 4 which has dimensions XA_{D} by YA_{D}. The printable surface 4 may be a paper roll, a washable surface, or a conveyor belt of a printable material for example. To accommodate ejection from all print heads 6, 8, 10, and 12 of the print carriage 1 the Y direction of the nozzle health measurement zone 3 printable surface 4 extends to accommodate the swath of the carriage 1. Therefore YA_{D} is equal to or greater than YA.

The width, XA_{D}, of the nozzle health measurement zone printable surface 4 may be a different width from the print head swath of carriage 1. For example in FIG. 1A the width of the nozzle health measurement zone printable surface 4 is less than the width of the carriage 1, and so each print head (6, 8, 10, and 12) will be measured separately. The X dimension is configurable and depends on how fast the drop detection is to be performed.

In operation, as carriage 1 translates along the scan axis through nozzle health measurement zone 3 print head 6 ejects print fluid onto printable surface 4. The carriage 1 then reverses its direction of motion to return and traverse the printable work surface 2 in the other direction revealing a print fluid drop pattern on the printable surface 4. The controller 13 transmits a control signal to the digital image recording device 5 to record an image 37 of the print fluid drop pattern 35. The recorded image 37 may then be processed and analysed by the image processor 7 to determine a result based on an image characteristic representative of the print fluid deposited on the printable surface 4. The controller 13 may use the result to assign a nozzle health category to the nozzles under test.

In the described disclosure, the digital image recording device 5 produces a digital image 37 which is 75 mm×4 mm and corresponds to a pixel area of 60×1834 pixels, which leads to a resolution of 245 pixels/cm (24.5 pixels/m or 622.3 pixels/inch).

FIG. 1B is an illustrative schematic diagram of the second system 9′ to determine print fluid ejection nozzle health in accordance with the present disclosure. The illustrated system 9′ comprises a digital image recording device 5 an image processor 7 and a controller 13. FIG. 1B illustrates a carriage 1 supporting print heads 6, 8, 10, and 12 with a swath of size YB by XB. The print heads 6, 8, 10 and 12 eject print fluid through their nozzles onto a printable work surface 2, such as a sheet of paper, while the carriage 1 traverses a print pass in the print scan axis (X-axis). In the described disclosure a nozzle health measurement zone 3′ is disposed to a side of the printable work surface 2 so that during a pass when the carriage starts to reduce its speed to change direction a nozzle health measurement may be launched.

The nozzle health measurement zone 3 comprises a printable surface 14 which has dimensions XB_{D} by YB_{D}. The printable surface 14 may be of a paper roll, a washable surface, or a conveyor belt of a printable material for example. To accommodate ejection from all print heads 6, 8, 10, and 12 of the print carriage 1, the Y direction of the nozzle health measurement zone 3 printable surface 14 extends to accommodate the swath of the carriage 1, therefore YB_{D} is equal to or greater than YA.

The width, XB_{D}, of the nozzle health measurement zone 3 printable surface 14 may be a different width from the carriage 1. For example in FIG. 1B the width XB_{D} of the nozzle health measurement zone 3′ printable surface 14 is greater than the width of the carriage 1, and so each print head (6, 8, 10, and 12) may be measured simultaneously. The X dimension is configurable and depends on how fast drop detection is to be performed.

In operation, as the carriage 1 translates along the scan axis through nozzle health measurement zone 3′ print heads 6, 8, 10, and 12 eject print fluid onto printable surface 14. The carriage 1 then reverses its direction of motion to return and traverse the printable work surface 2 in the opposite direction revealing print fluid drop patterns for each print head on the printable work surface 14. The controller 13 sends a control signal to the digital image recording device 5 to record an image of the print fluid drop patterns. The recorded image may then be processed and analysed by the image processor 7 to determine a result based on an image characteristic representative of the print fluid deposited on the printable surface 14. The controller 13 may use the result to assign a nozzle health category to the nozzles 6′, 8′, 10′ and 12′ under test.

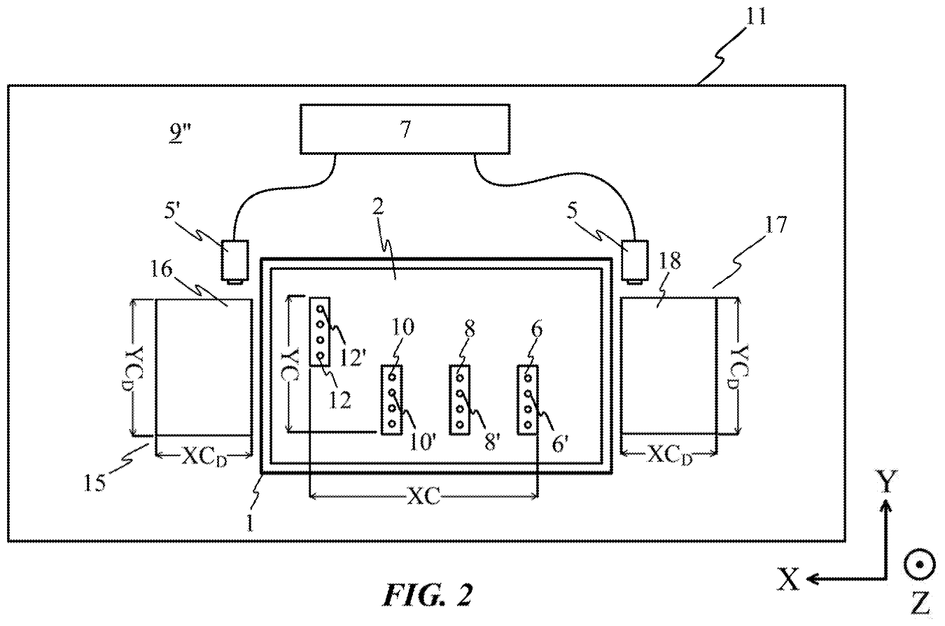

The nozzle health measurement zone 3′ does not have to be disposed to one side of the printable work surface. FIG. 2 is an illustrative schematic diagram of a third example of system 9″ to determine print fluid ejection nozzle health in accordance with the present disclosure. FIG. 2 illustrates a carriage 1 supporting print heads 6, 8, 10, and 12 with a swath of size YC by XC. The print heads 6, 8, 10 and 12 eject print fluid through their nozzles onto a printable surface 2, such as a sheet of paper, while the carriage 1 traverses a print pass in the print scan axis (X-axis). In the described disclosure nozzle health measurement zones 15 and 17 are disposed to both sides of the work surface 2 so that in a pass when the carriage 1 starts to reduce its speed to change direction a nozzle health measurement may be launched on either side or both sides of the printable work surface 2.

The nozzle health measurement zones 15 and 17 comprise printable surfaces 16 and 18 respectively and have dimensions XC_{D} by YC_{D}. The printable surfaces 16 and 18 may be of a paper roll, a washable surface, or a conveyor belt. To accommodate ejection from all print heads 6, 8, 10 and 12 of the print carriage 1 the Y direction of the nozzle health measurement zones 15 and 17 printable surface 4 extend to accommodate the swath of the carriage 1, therefore YC_{D} is equal to or greater than YC.

The width, XC_{D}, of the nozzle health measurement zone printable surfaces 16 and 18 may be a different width from that of the carriage 1. For example, in FIG. 2 the widths of the nozzle health measurement zone printable surfaces 16 and 18 are less than the width of the carriage 1, and so each print head (6, 8, 10, and 12) may be measured individually. The X dimension is configurable and depends on how fast the drop detection is to be performed.

Nozzle health measurement zones 15 and 17 are disposed to the left and right of printable work surface 2 respectively. As the carriage 1 translates along the scan axis through nozzle health measurement zone 17 print heads 6, 8, 10, and 12 may respectively or simultaneously eject print fluid onto printable surface 18. The carriage 1 then reverses its direction of motion to return and traverse the work surface 2 in the other direction revealing print fluid drop patterns for each print head 6, 8, 10 and 12 on the printable work surface 18. The controller 13 sends a first control signal to first digital image recording device 5 to record an image of the print fluid drop patterns. The recorded image may then be processed and analysed by the image processor 7 to determine a result based on an image characteristic representative of the print fluid deposited on the printable surface 18. The controller 13 may use the result to assign a nozzle health category to the nozzles under test.

The carriage 1 continues traversing printable work surface 2 through to nozzle health measurement zone 15 where print heads 6, 8, 10, and 12, may individually or simultaneously eject print fluid onto printable surface 16. The carriage 1 then reverses its direction of motion to return and traverse the work surface 2 in the original direction revealing a second print fluid drop pattern on printable work surface 16. The controller 13 sends a second control signal to the second digital image recording device 5′ to record an image of the print fluid drop patterns. The recorded image may then be processed and analysed by the image processor 7 to determine a result based on an image characteristic representative of the print fluid deposited on the printable surface 16. The controller 13 may use the result to assign a nozzle health category to the nozzles under test.

The print fluid drop patterns ejected by the print heads 6, 8, 10 and 12 onto nozzle health measurement zones 15 and 17 may be any combination of print fluid drop patterns.

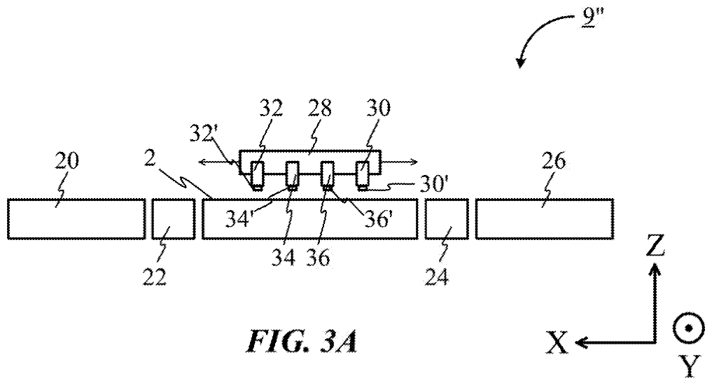

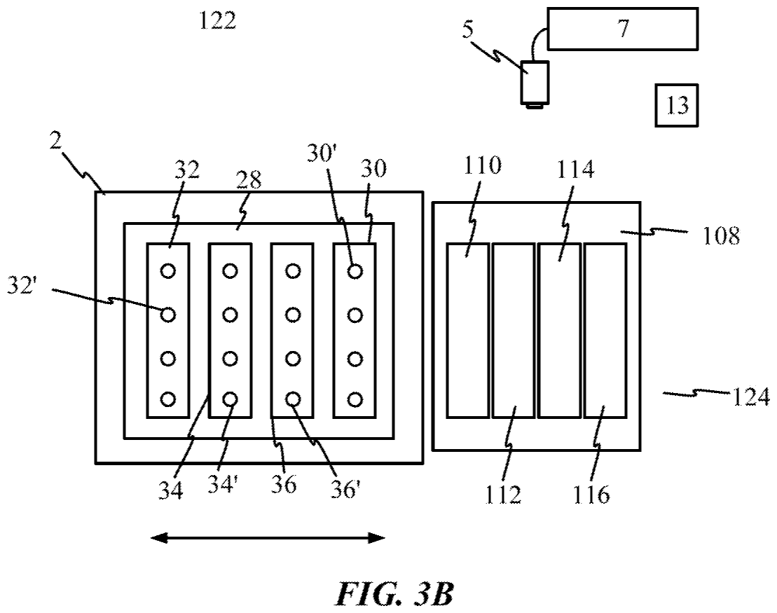

FIG. 3A is an illustrative schematic diagram of a fourth example of a system 9″ to determine print fluid ejection nozzle health in accordance with the present disclosure. FIG. 3A illustrates a carriage 28 supporting print heads 30, 32, 34, and 36. The print heads 30, 32, 34, and 36 eject print fluid through their nozzles 30, 32′, 34′ and 36′ onto a printable surface 2, such as a sheet of paper, while the carriage 28 traverses a print pass in the print scan axis (X-axis). The print pass direction is shown by the arrows in FIG. 3A. In the described disclosure nozzle health measurement zones 22 and 24 are disposed to respective sides of the printable work surface 2 so that for each pass when the carriage 28 starts to reduce its speed to change direction a nozzle health measurement may be launched on either side.

FIG. 3A also illustrates print head servicing zone 20 disposed to the left of nozzle health measurement zone 22 and print head servicing zone 26 disposed to the right of nozzle health zone 24. If the controller 13 assigns a nozzle health category which may result in unsatisfactory printing conditions the controller 13 can instruct the carriage 28 to traverse to either of the print head servicing zones 20 or 26 for maintenance.

FIG. 3B is an illustrative schematic diagram of a fifth example of a system 122 to determine print fluid ejection nozzle health in accordance with the present disclosure. FIG. 3B illustrates a carriage 28 supporting print heads 30, 32, 34, and 36. The print heads 30, 32, 34, and 36 eject print fluid through their nozzles 30, 32′, 34′ and 36′ onto a printable surface 2, such as a sheet of paper, while the carriage 28 traverses a print pass in the print scan axis (X-axis). The print pass direction is shown by the arrows in FIG. 3B. In the described disclosure nozzle health measurement zone 108 is disposed to one side of the printable work surface 2 so that for each pass when the carriage 28 starts to reduce its speed to change direction a nozzle health measurement may be launched.

The Y direction of the nozzle health measurement zone 124 printable surface 108 does not extend to accommodate the entire swath of the carriage 28. To accommodate ejection from all print heads 30, 32, 34, and 36 of the print carriage 28, the controller 13 transmits a control signal to the carriage 28 and print heads 30, 32, 34, and 36 such that the distance between print fluid drop patterns 110, 112, 114, and 116 is less than the distance between the print heads 30, 32, 34, and 36.

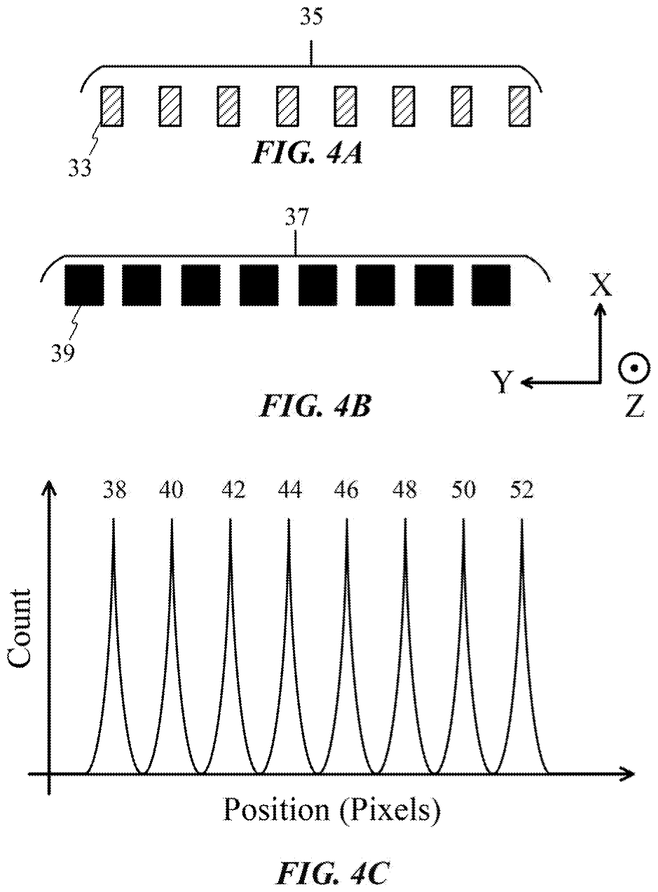

FIG. 4A is an illustrative schematic of a print fluid drop pattern 35 which has been ejected by either or all print heads 6, 8, 10 or 12 onto printable surface 4. In this instance the print fluid drop pattern 35 includes eight regions of 100 print fluid drops spaced in the X direction and extending in the Y direction. The print fluid drop pattern 35 may be recorded by digital image recording device 5 and processed and analysed by image processor 7. A print fluid drop, or plurality of print fluid drops, may be ejected by a single nozzle of a print head 6, 8, 10, 12. The print fluid droplet region 33 may be any colour and is represented by generic hatching in FIG. 4A. Other print fluid drop patterns may be used to determine print fluid ejection nozzle health depending on the use and printer 11 set up.

FIG. 4B is a schematic illustration of a stage of the process and analysis of the image of the print fluid drop pattern 35 by image processor 7. The image data representative of the print fluid drop pattern 35 is converted to a black and white image 37 using image processing such that the density of the print fluid in the image is represented by the inverse of the density of black colour in the black and white image. Each pixel weight is evaluated in the image processor 7 to get a numerical value between 0 or 1 resulting in the black and white image observed in FIG. 4B. The analysis may be on a pixel by pixel basis; by a print region 33 by print region 33 basis; or all pixels simultaneously. The black squares 39 represent the space between the print fluid drops 33. The black and white image 37 is processed to derive a numerical value to produce the graph as seen in FIG. 4C.

The graph of FIG. 4C illustrates a value indicative of the pixel values of the black and white image 37 on the Y axis and the position on the X axis. The graph contains eight peaks 38, 40, 42, 44, 46, 48, 50, 52. Each peak corresponds to a print fluid drop region within print fluid drop pattern 35. For example, peak 38 corresponds to the analysis of print fluid drop region 33. The number of white pixels in the Y direction of the black and white image 37 is represented by the height of the peaks in FIG. 4C, i.e. it is an integration in the Y direction of the image.

Image processor 7 determines a result based on an image characteristic representative of the print fluid deposited on a printable surface 4, 14, 16, 18, 22 or 214. The controller 13 may use the result to assign a nozzle health category to the nozzles under test. In the case illustrated in FIG. 4C the nozzles in the print that are deemed to be working with good health are those with a high count per peak.

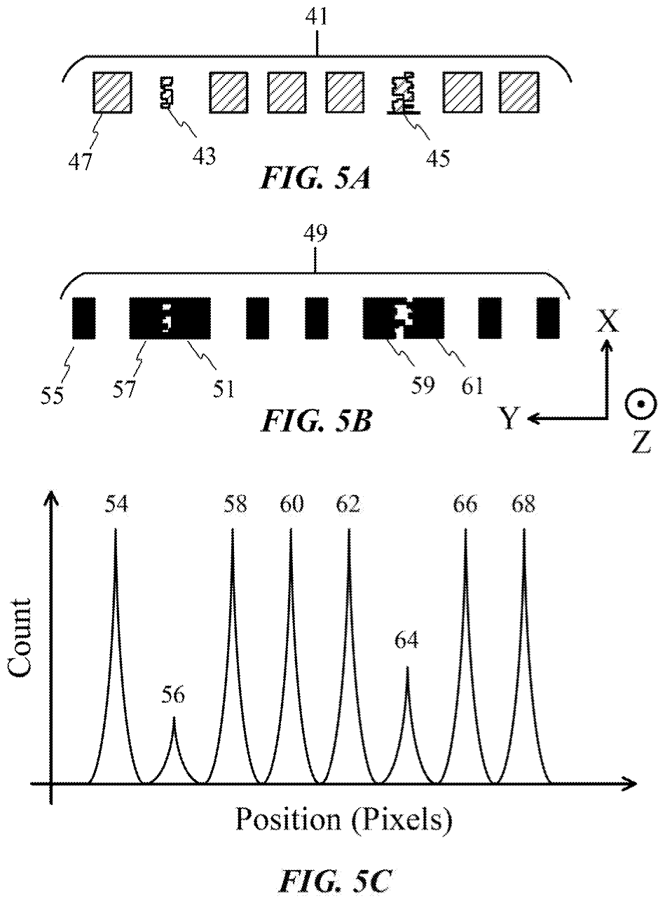

FIG. 5A is an illustrative schematic of a print fluid drop pattern 41 which has been ejected by a print head 6, 8, 10 or 12 onto printable surface 4. In this instance the print fluid drop pattern 41 includes eight print fluid drops which are not all equally spaced in the X direction and do not all have the same size in the Y direction. Two of the print fluid drop regions 43 and 45 correspond to respective nozzles which are deemed to be not working and a weak or poor health nozzle respectively. The size of the print fluid drop region is indicative of the amount of print fluid ejected by a print head nozzle and therefore is indicative of the nozzle health.

The print fluid drop pattern 41 is processed into a black and white image 49 as schematically illustrated in FIG. 5B. Black squares 55, 57, 51, 59, and 61 represent the space between the print fluid drops in print fluid pattern 41. This black and white image 49 is processed to derive a numerical value and to further produce the graph as seen in FIG. 5C. Black squares 51 and 57 within black and white image 49 have almost merged together due to the fact that the nozzle which deposited print fluid region 43 has not ejected enough printing fluid due to a possible malfunction.

The peak 56 corresponds to the analysis of print fluid region 43 shown in FIG. 5A. The height of peak 56 is lower than the neighbouring peaks 54 and 50 respectively due to the fact that the nozzle which deposited print fluid region 43 may have a malfunction and therefore the subsequent analysis yielded a low count of white pixels in black and white image 49. The controller 13 may then assign a health status to the nozzle which deposited print fluid region 33 and may apply error hiding procedures based upon this result. The peak 64 has a higher value than the peak 56 because it corresponds to analysis of print fluid region 45 which contains more print fluid than print fluid region 43.

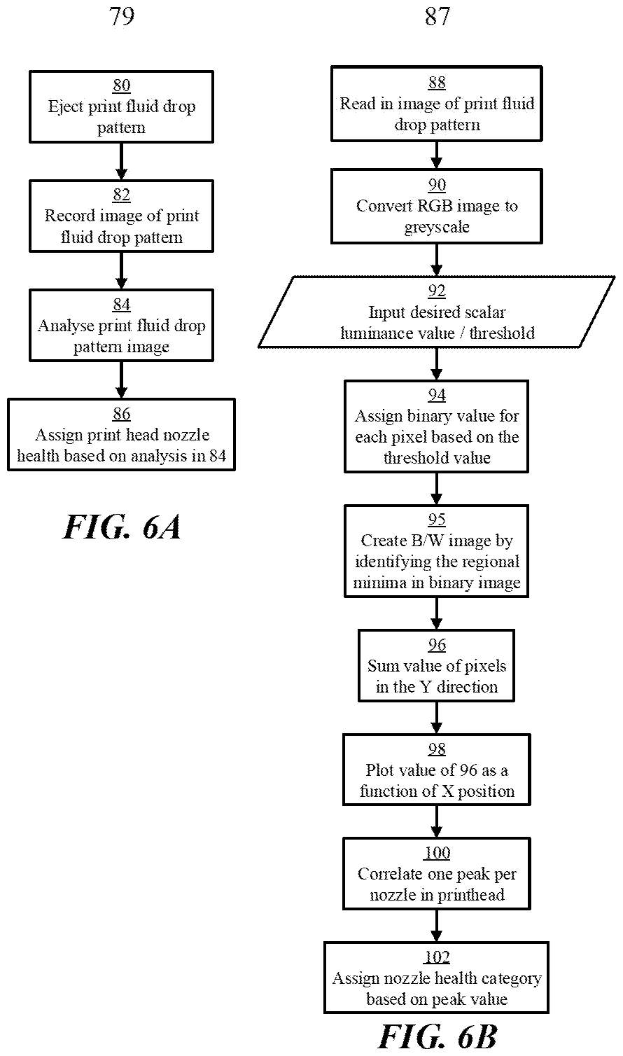

An example of a process of the nozzle health detection system is schematically illustrated in the flowchart 79 in FIG. 6A. In the first stage, 80, the print head nozzles eject a print fluid drop pattern; next, stage 82, an image of the print fluid drop pattern is recorded by an image recording device; at stage 84 the print fluid drop pattern is analysed; and finally, at stage 86, a print head nozzle health is assigned based on the analysis of the image taken by an image recording device.

In the described disclosure, the controller 13 operates in accordance with process flow control diagram 87 illustrated in FIG. 6B. Process flow control diagram 87 sets out operation of the image processor 7 implemented in the microcontroller by way of a set of executable instructions, which may be referred to as a computer program, routine or application.

Operation of the controller 13 and image analyser 7 in accordance with the process flow control diagram 87 starts with the controller 13 reading in the digital image of the print fluid drop pattern, 88. Then, process control flows to the next stage, 90, at which the stage controller 13 converts the image from RGB to greyscale by eliminating the hue and saturation information while retaining the luminance. The controller 13 may request user input of a desired skill luminance value which is to be used as a threshold, 92. The threshold is to be between 0 and 1.

In the described disclosure, the controller 13 assigns a binary value for each pixel based on the threshold value input by the user, 94. This is achieved by replacing all values above the threshold with 1 and setting all other values to 0. In this way the user can customise the binary image produced by the controller 13.

Process control may then flow to stage 95 at which the controller 13 produces a black and white image by identifying the regional minima of the binary image produced in stage 94. Process control may then flow to stage 96 in which the controller 13 sums the values of the black and white pixels in the Y direction and then to stage 98 in which controller 13 plots the value from stage 96 as a function of X position to produce the graphs seen in FIG. 4C and FIG. 5C. The process control then flows to stage 100 where the individual peaks are correlated to a particular nozzle of the print head. This may be by way of automatic or manual calibration. Finally at stage 102 the controller 13 assigns a nozzle health category based on the calculated peak value corresponding to the nozzle.

Insofar as the disclosure described above is implementable, at least in part, using a machine readable instruction-controlled programmable processing device such as a general purpose processor or special-purposes processor, digital signal processor, microprocessor, or other processing device, data processing apparatus or computer system it will be appreciated that a computer program for configuring a programmable device, apparatus or system to implement the foregoing described methods, apparatus and system is envisaged as an aspect of the present disclosure and claimed subject matter. The computer program may be embodied as any suitable type of code, such as source code, object code, compiled code, interpreted code, executable code, static code, and or dynamic code, for example. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The term “computer” in its most general sense may encompass programmable devices such as referred to above, and data processing apparatus and computer systems in whatever format they may arise, for example, desktop personal computer, laptop personal computer, tablet, smart phone or other computing device.

The computer program may be stored on a computer readable storage medium in machine readable form, for example the computer readable storage medium may comprise memory, removable or non-removable media, erasable or non-erasable media, writeable or re-writeable media, digital or analogue media, hard disk, floppy disk, Compact Disk Read Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD) subscriber identity module, tape, cassette solid-state memory. The computer program may be supplied from a remote source and embodied in a communications medium such as an electronic signal, radio frequency carrier wave or optical carrier waves. Such carrier media are also envisaged as aspects of the present disclosure.

Although examples of the disclosure have been described with reference to an image processor and a controller illustrated as separate processor resources, the image processor and controller may be integrated in the same circuitry, circuit or processor module. For example, a programmable integrated circuit such as a microprocessor or microcontroller programmed to implement the functions of the image processor and controller may be used. Other programmable devices such as referred to above may be used also and or instead. The term controller may be discreet control circuitry likewise term module may be discreet control circuitry.

Examples of the disclosure have been described with reference to print fluid, this may refer to printer ink, build material for use in 3D printers or any other printable material. Furthermore, examples of the disclosure have been described with reference to 2D printing, however, the term ‘printer’ may also reference a 3D printer that prints on a bed of build material. A printable surface may be a surface on which build material is deposited.

As used herein any reference to “one disclosure” or “a disclosure” means that a particular element, feature, structure, or characteristic described in connection with the disclosure is included in at least one disclosure. The appearances of the phrase “in one disclosure” or the phrase “in an disclosure” in various places in the specification are not necessarily all referring to the same disclosure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the disclosure. This is done merely for convenience and to give a general sense of the disclosure. This description should be read to include one or at least one and the singular also includes the plural unless it is obvious that it is meant otherwise.

Various modifications may be made within the scope of the disclosure. For example, a print fluid pattern may not be printed on a printable surface each time a carriage traverses nozzle health measurement zone. It may occur at other intervals.

The scope of the present disclosure includes any novel feature or combination of features disclosed therein either explicitly or implicitly or any generalisation thereof irrespective of whether or not it relates to the claimed subject matter or mitigates against any or all of the issues addressed by the present disclosure. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

1. A system to determine print fluid ejection nozzle health for a printer device, the system comprising:
an image recording device to record an image of print fluid ejected from a print fluid ejection nozzle and disposed on a printable surface;
an image processor to analyse the image to provide a value based on a characteristic of the image representative of the print fluid disposed on the printable surface; and
a controller to receive the value and assign a nozzle health category to the print fluid ejection nozzle in dependence on the value.

2. The system of claim 1, wherein the image processor is to determine the value so as to be representative of an amount of print fluid disposed on the printable surface from the print fluid ejection nozzle.

3. The system of claim 1, wherein the image processor is to convert the value to a binary digit value.

4. The system of claim 3, wherein the controller is to assign a first nozzle health category for the binary digit value being 1 and a second nozzle health category for the binary digit value being 0.

5. A printer, comprising:
a print head carriage to move a print head comprising a print fluid ejection nozzle through a print zone of the printer;
a printable surface disposed outside of the print zone, the print head movable on the print head carriage to a nozzle test position to eject print fluid onto the printable surface;
an image recording device to record an image of print fluid ejected from the print fluid ejection nozzle and disposed on the printable surface;
an image processor to analyse the image to provide a value based on a characteristic of the image representative of the print fluid disposed on the printable surface; and
a controller to receive the value and assign a nozzle health category to the print fluid ejection nozzle in dependence on the value, the controller to output a signal to initiate the print fluid ejection nozzle to eject print fluid onto the printable surface.

6. The printer of claim 5, wherein the controller is to output a first signal to control movement of the print head to the nozzle test position and output a second signal to initiate the print fluid ejection nozzle to eject print fluid onto the printable surface in the nozzle test position.

7. The printer of claim 5, wherein the printable surface is disposed to a side of the print zone.

8. The printer of claim 5, wherein the controller is to control movement of the print head to the nozzle test position and the print fluid ejection nozzle to eject print fluid onto the printable surface for each pass of the print head on the print head carriage.

9. The printer of claim 5, wherein the printable surface comprises a wipe clean surface or a roll of paper moveable to provide a clear printable surface for receiving print fluid ejected from the print fluid ejection nozzle for each excursion of the print head to the nozzle test position.

10. A method to determine print fluid ejection nozzle health for a printer device, the method comprising:
recording an image of print fluid ejected from a print fluid ejection nozzle and disposed on a printable surface;
analysing the image to provide a value based on a characteristic of the image representative of the print fluid disposed on the printable surface; and
assigning a nozzle health category to the print fluid ejection nozzle in dependence on the value.

11. The method of claim 10, further comprising determining the value so to be representative of an amount of print fluid disposed on the printable surface from the print fluid ejection nozzle.

12. The method of claim 10, further comprising converting the value to a binary digit value.

13. The method of claim 12, further comprising assigning a first nozzle health category for the binary digit value being 1 and a second nozzle health category for the binary digit value being 0.

14.-15. (canceled)

16. The printer of claim 5, wherein the image processor is to determine the value so as to be representative of an amount of print fluid disposed on the printable surface from the print fluid ejection nozzle.

17. The printer of claim 5, wherein the image processor is to convert the value to a binary digit value.

18. The printer of claim 17, wherein the controller is to assign a first nozzle health category for the binary digit value being 1 and a second nozzle health category for the binary digit value being 0.
